(19) United States
(12) Patent Application Publication
(10) Pub. No.: US 2010/0186251 A1
(43) Pub. Date: Jul. 29, 2010

(54) ADSORPTION DRYER

(75) Inventor: Andreas Stolze, Falkensee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/668,445

(22) PCT Filed: Jul. 10, 2008
(86) PCT No.: PCT/EP2008/059008

§ 371 Date: Jan. 11, 2010

(30) Foreign Application Priority Data
Jul. 18, 2007 (DE) 10 2007 033 494.1

(51) Int. Cl. F26B 3/347; D06F 58/00; F26B 3/00

(52) U.S. Cl. 34/263; 34/92; 34/273; 34/409

(57) ABSTRACT

A dryer device having a receiving chamber for receiving textiles and drying agents including a vacuum pump for creating a vacuum in the receiving chamber. A drying method includes introducing textiles and drying agents, particularly based on zeolite, into the receiving chamber, followed by a vacuum being created in the receiving chamber.

The invention relates to a dryer device comprising at least one receiving chamber for receiving textiles and drying agent, and to a corresponding method.

To avoid shrinkage when drying woolen or silk textiles in a condensing dryer or exhaust dryer these textiles must not be randomly turned during the drying process because movement causes them to shrink. Furthermore, the temperatures to which the textiles are subjected are often quite high in a conventional dryer.

Baskets are known for avoiding movement of a sensitive textile material in a conventional tumble dryer, said baskets being fixed in the interior of the drum of a conventional tumble dryer and the textiles resting thereon. The drying times when using a basket of this kind are often very long and the energy consumption is high.

DE 26 26 887 A1 discloses a tumble dryer in which heated air is conducted via a fan and a heating device to the washing and then removes moisture from the washing. A drying agent receptacle is interconnected in the air conduction system, so that air laden with moisture passes into the receptacle and the drying agent adsorbs the moisture in the process air. Bead-like adsorbent drying agents based on zeolite are preferably used as the drying agents. A high level of efficiency is to be achieved through the potential for heat recovery.

A laundry processing machine is known from DE 43 38 366 A1 in which in an at least approximately horizontal rotatably mounted washing drum the washing can be tossed about during the movements of the drum, wherein to dry the washing the latter is only brought into indirect contact with hygroscopic material by way of special water-permeable woven textile parts. The hygroscopic material comprises polyacrylic resin granules which are allowed to touch the damp textiles, but, to avoid gel-like softening, must not touch them directly.

It is the object of the present invention to provide a possibility for gentle and energy-efficient drying of textiles, such as wool or silk, which, in particular, are not suitable for a conventional drum-type dryer.

This object is achieved by a dryer device as claimed in claim 1 and a drying method as claimed in claim 7. Advantageous embodiments can be found in the subclaims in particular. Advantageous embodiments of the dryer device correspond to advantageous embodiments of the drying method and vice versa, even if reference is not made thereto in each individual case.

The dryer device comprises at least one receiving chamber for receiving textiles and drying agents, as well as a vacuum pump for creating a vacuum in the at least one receiving chamber. The vacuum causes water to evaporate from the textiles. The water is distributed in the receiving chamber and is absorbed by the drying agent. Therefore no energy needs to be applied to heat the air to dry the textiles. Furthermore, the vacuum can also be maintained for a relatively long period substantially without loss and without high expenditure on apparatus. The textiles do not need to be moved either as the vacuum has an even effect. Furthermore, evaporation proceeds at a comparatively low temperature. The drying rate depends inter alia on the level of the vacuum.

With a stronger vacuum, heat from evaporation is removed from the water in the textiles relatively quickly until a remaining quantity of water freezes. The adsorption process is initially stopped as a result and drying is no longer possible in this state. With a sufficiently long waiting time the frozen water is adapted to the temperature of its surroundings again by heat balancing processes and condenses, although a procedure of this kind can take as long as until the textiles are completely dry.

For faster drying it is therefore preferably provided that the dryer device also comprises a heating device for heating the textiles, preferably a heat radiator, in particular an infrared radiator and/or a microwave radiator. The microwave radiator is advantageously matched to the drying agent. Consequently, using an energy input that is still comparatively low and, moreover, easily adjustable, the textiles can be heated to the extent that the water is prevented from freezing, so the entire drying process can proceed much more quickly. Switching-on of the heating device can also be time-controlled, for example not until a predetermined period after the start of a drying process.

The heating device means that, in a separate process, the water can be removed from the drying agent again as a result of the heating thereof.

A fan for air-cooling the drying agent is also preferably provided. As the drying agent and the textiles are connected to each other by way of air, the adsorption heat dissipated by the fan will also reach the textiles and heat them. Depending on the construction of the dryer and the quantity of drying agent and textiles, the heating device can even be omitted or need only be switched on at the start of the drying process. The energy consumption of the dryer is therefore reduced further.

For simpler handling at least two connected receiving chambers are provided, namely at least one first receiving chamber for receiving the textiles and a second receiving chamber for receiving the drying agent. These can preferably be filled separately.

With the above arrangement it is not necessary for the at least one receiving chamber to rotate; constructionally simple, sealed receiving chambers are preferably sufficient.

The use of zeolite as the drying agent is particularly advantageous as it is easy to handle, has a high adsorption effect and can be easily regenerated.

The invention will be schematically described in more detail in the following exemplary embodiment.

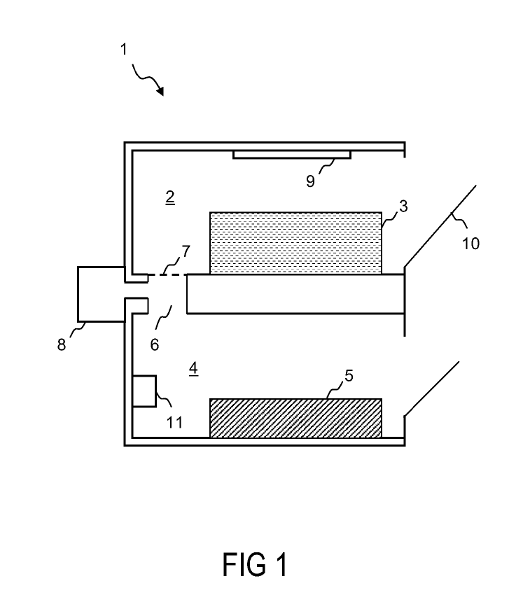

FIG. 1 shows a sketch of a dryer device in cross-section.

FIG. 1 shows a zeolite adsorption dryer 1 for a gentle low-temperature drying process. The dryer 1 has a first upper receiving chamber 2 for receiving textiles 3, and a second lower receiving chamber 4 for receiving drying agent 5, based on zeolite in this example. The two receiving chambers 2, 4 are joined by a connecting channel 6 that is secured to the upper receiving chamber 2 by a grate 7. The receiving chambers 2, 4 are constructed, for example with appropriate seals on a respective door 10, in such a way that they can effectively maintain a vacuum created therein by a vacuum pump 8. Attached to its cover the upper receiving chamber 2 has an infrared radiator 9 for heating the textiles 3. The infrared radiator 9 is controlled by means of a controller (not shown), for example within the framework of a predetermined program sequence.

In general the weight of the drying agent 5 (here: zeolite) should be matched to the maximum amount of water to be adsorbed from the textiles 3. With an assumed maximum water load, for example of zeolite, of 20%, 2.5 kg of zeolite are required for 500 g of water. This volume of water can be removed from 1 kg of textiles with 50% initial residual moisture.

At the start of a drying process the textiles 3 for drying are placed in the upper receiving chamber 2. The zeolite 5 must be present in the lower receiving chamber 4, be it already stored there or introduced with the textiles 3. The receiving chamber 2, 4 which is divided in two is then subjected to a vacuum by means of the pump 8. The zeolite 5 starts to adsorb the water from the washing 3. Energy is supplied by means of the infrared radiator 9 in order to not allow the water to freeze as a consequence of the heat of evaporation that has been removed. Drying temperature and speed can be determined by the power input of the infrared radiator. With a connected load of 1500 W the described 1 kg of textiles dries in about 15-20 minutes for example. At the end of the drying process the upper receiving chamber 2 is opened again for the textiles 3 to be removed.

As the adsorption capacity of zeolites 5 is limited it has to be regenerated after a number of drying cycles. For this purpose the zeolite receptacle 5 can, for example, be removed from the lower receiving chamber 4 and be placed in the upper receiving chamber 2. There, with the door 10 open, it can be heated to the temperature optimal for desorption, so the water contained in the zeolite 5 evaporates and is discharged to the external surroundings through the door 10. For the cooling phase that advantageously follows a new drying process the zeolite 5 can be reintroduced into the lower receiving chamber 4 and be cooled there, assisted by a fan 11. The same fan 11 can also be used to cool the zeolite under vacuum during the textile drying process, so the textile drying process is accelerated even more and the infrared radiator 9 can optionally be partially or completely omitted. As far as possible the receiving chamber 2, 4 should be sealed in an air-tight manner until the next drying process, for example by air-tight door seals, so the zeolite 5 does not adsorb any atmospheric moisture.

Obviously the invention is not restricted to the embodiment described above.

### LIST OF REFERENCE CHARACTERS

1 dryer
2 upper receiving chamber
3 textiles
4 lower receiving chamber
5 drying agent
6 connecting channel
7 grate
8 vacuum pump
9 infrared radiator
10 door
11 fan

1-10. (canceled)

11. A dryer, comprising:
a receiving chamber with a first receiving chamber for receiving textiles and a second receiving chamber for receiving a drying agent and connected to the first receiving chamber; and
a vacuum pump for creating a vacuum in the receiving chamber.

12. The dryer of claim 11, further comprising a heater for heating the textiles.

13. The dryer of claim 12, wherein said heater comprises an infrared radiator and/or a microwave radiator.

14. The dryer of claim 11, further comprising a fan for air-cooling the drying agent.

15. The dryer of claim 11, wherein the receiving chamber can be operated so as not to rotate.

16. The dryer of claim 11, wherein the drying agent comprises a zeolite.

17. A drying method, comprising
introducing textiles into a first receiving chamber;
introducing a drying agent into a second receiving chamber connected to the first receiving chamber; and
creating a vacuum in the receiving chamber.

18. The method of claim 17, wherein the drying agent comprises a zeolite.

19. The method of in claim 17, further comprising a heater for heating the textiles during the vacuum.

20. The method of claim 17, further comprising a heater for heating the textiles by means of infrared and/or microwave radiation.
